(19) United States
(12) Patent Application Publication
(10) Pub. No.: US 2011/0208617 A1
(43) Pub. Date: Aug. 25, 2011

(54) SYSTEM AND METHOD FOR LOCALITY AND USER PREFERENCE BASED FOOD RECOMMENDATIONS

(76) Inventor: Chris Weiland, Easton, CT (US)

(21) Appl. No.: 13/031,162

(22) Filed: Feb. 18, 2011

Related U.S. Application Data
(60) Provisional application No. 61/306,442, filed on Feb. 19, 2010.

(51) Int. Cl. G06Q 30/00

(52) U.S. Cl. 705/27.1

(57) ABSTRACT

A system and methods for generating and presenting recommendations of places to eat based on a user's preferences and profile. A set of preferences and ratings are maintained by multiple users which are used to filter and generate rating estimations. Preferences and ratings of other user's with similar preference profiles are used to increase or decrease the recommendations. The location and preferences of multiple users can also be compared to provide eating recommendations for a group of users. The recommendations and ratings can be drilled down to specific menu item for determining recommendations on the full meal or a specific item. The system can also be used by the restaurant owner to identify potential customers, target marketing messages, identify problems with the menu or staff, and improve the impression and quality of the restaurant and food.

### RELATED APPLICATION

This application claims priority to U.S. Provisional Patent Application 61/306442 filed on Feb. 19, 2010 by Chris Weiland, the entirety of which is incorporated herein.

### BACKGROUND OF THE INVENTION

1. Field of the Invention

The present invention relates generally to a system and method for identifying recommended restaurants, meals, and chefs based upon user identified criteria and estimated user ratings. More particularly, the invention relates to a system and method for identifying restaurants, meals or chefs based upon location, user selected criteria, and an estimation of a user's ratings based upon a user's past ratings and the ratings and profiles of other users.

2. Description of the Related Art

Photographers continually suffer with finding a solution to diffusing the detrimental effects caused by harsh direct flash. Intense direct flash is unfavorable in that the flash light source is a harsh point source of light. One skilled in the art of photography understands that “bounce flash,” (i.e., flash aimed away from the object, such as at a light-colored surrounding wall and/or ceiling which is allowed to bounce toward the object) is one solution that will soften the intense illuminating and shadowing effects of direct flash and cast a smoother continuous hue of neutral lighting on the object being photographed to produce a more pleasing photograph.

The computer network referred to as the Internet or World Wide Web allows for information sharing in an easily searchable form as well as allowing various links from one website to another to connect together such items as maps, directions, reviews, photographs, descriptions, advertising, and promotional materials. This information is also applicable to users using technology such as smart phones, PDAs or other communication devices utilized to share information. The food service industry is particularly well-suited to such information sharing because there are a wide variety of restaurant types, foods, atmosphere, cost, location and customer preferences.

Consumers have a wide variety of choices when it comes to restaurants and eating establishments. Consumers are faced with many questions when selecting an establishment including location, price, availability, style, atmosphere, menu, chefs, particular meals and other factors. Consumer's are also interested in the opinions of others and their experience with a given establishment, meal or chef. Review sites which allow users to rate or provide reviews of restaurants are available on the internet or World Wide Web (www). However, since many customers may visit the same establishment and have a different opinion it can often be difficult to determine if one person's rating and/or review of a restaurant will be particularly relevant to the individual searching for a place to eat. As more people rate or review a particular restaurant a general opinion can be evaluated, but that opinion may not be applicable to all aspect of a restaurant or particularly relevant to new patrons with different tastes.

The present invention solves the problem of locating a given type of restaurant, chef or menu item in a given location while both recommending establishments based upon estimated ratings and preferences and allowing for a prospective patron to read reviews of the restaurants, peruses menus, and/or view photographic or video material of the restaurant. This enables the patron to select a specific restaurant which meets certain criteria, and then to obtain maps of or directions to the restaurant, along with the possibility of obtaining coupons or other materials. It also allows restaurants to receive deep feedback and for smaller restaurants to gain valuable recognition and marketing opportunities, so they are able to compete with larger establishments for prospective patrons.

### SUMMARY OF THE INVENTION

This summary is provided to introduce concepts in a simplified form that are further described in the detailed description of the invention. This summary is not intended to identify key or essential inventive concepts of the claimed subject matter, nor is it intended for determining the scope of the claimed subject matter.

The components of the invention are a complete restaurant search guide and rating system which is available through the interaction of a user interface. The user interface or website is accessible through a computer, smart phone, or other communication device which connects to the Internet or the World Wide Web. The system enables restaurant owners to upload desired information such as menus and menu items, prices, photographs, videos, information, and/or marketing materials which will help guide and educate prospective patrons. In addition, users of the system are able to provide ratings and reviews of restaurants, chefs, and menu items. Users are also able to search for establishments meeting certain criteria such as location, price, type or style of food, availability for seating, or the like. The system also creates a user's preference profile which is used to analyze, compare, and determine estimated ratings for determining and recommending restaurants, chefs, and meals.

Through the user's ratings, reviews, preferences, patterns, and criteria the system is able to both recommend establishments, chefs, and meals to users but to also provide deep feedback to restaurant owners and chefs. This feedback can be used to modify menus, highlight chefs and items, and provide targeted marketing opportunities to prospects

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 illustrates a restaurant, chef, or dish search, rating, and recommendation system employing the teachings of the present invention;

FIG. 2 illustrates a system and application diagram of the present invention;

FIG. 3 illustrates a user selected queue of restaurants, chefs, or dishes according to an aspect of the present invention;

FIG. 4 illustrates a process of generating recommendations in accordance with the present invention;

FIG. 5 illustrates suggested restaurants, chefs, or dishes based upon estimated user ratings in accordance with the present invention;

FIG. 6 illustrates a process of generating recommendations factoring in location in accordance with the present invention; and

FIG. 7 illustrates a process of generating recommendations factoring in the location and estimated user ratings of more than one user in accordance with the present invention.

### DETAILED DESCRIPTION OF EXEMPLARY EMBODIMENTS

Particular embodiments of the present invention will now be described in greater detail with reference to the figures.

A restaurant search system and guide is provided which employs various servers, computers, databases and guides allowing restaurant patrons and restaurant owners to provide and access restaurant information including menus, ratings, review, offers, contact and map or location information.

By way of example, a restaurant owner using a computer or other communication device 150 to connect to the Internet or World Wide Web 110 can upload data to the system and into the restaurant search guide, such as menus, ingredients, prices, photographs, videos, specials, or marketing/advertising materials. The system may comprise one or more servers or computers 120, 122 and one or more databases 125, 127. The servers 120, 122 contain the software and applications which provide access to the website, software applications, files, and one or more databases. The software applications resident on the servers 120, 122 include numerous applications.

Such applications include ratings, surveys, filtering, comparative analysis or analytics, ratings estimator, focused messaging and more. The ratings functionality enables users to rate restaurants, chefs, and specific meals and can display and analyze the ratings. The survey application can be used to identify likes and dislikes of users to enhance the user's preference profile. The survey application can also be used to provide restaurant owners and their chefs with feedback on many aspects of their establishment.

The filtering application enables the restaurants, chefs, and dishes or meals to be searched and filtered based on many criteria including the type of food, price, availability, specials, reviews, ratings, and more. The comparative analysis application is utilized to compare the restaurants ratings and profile to a user's preferences. The comparative analysis application is also utilized to identify other users of the system with similar tastes and preferences and to identify other restaurants, chefs, meals, and ingredients for comparative analysis. The ratings estimator is used to estimate and predict user ratings based on restaurant, chef and dish profiles, the user's existing ratings, system ratings, similar user profile ratings, location, specials, ingredients and other factors.

The focused messaging application enables restaurant owners and chefs to identify target patrons and communicate or market to them. Such application would enable owners to identify patrons who are local and whose preference profile matches a certain dish or special (i.e. a seasonal dish or new menu item). The owner could then send targeted marketing messages to that user to increase the likelihood of converting the user to a patron. The focused messaging application would also enable users and owners to interact with specific feedback on a specific dining experience or menu items. This might include messaging about catering to an allergy or party, or to discuss a user's review of a particular meal including likes and dislikes.

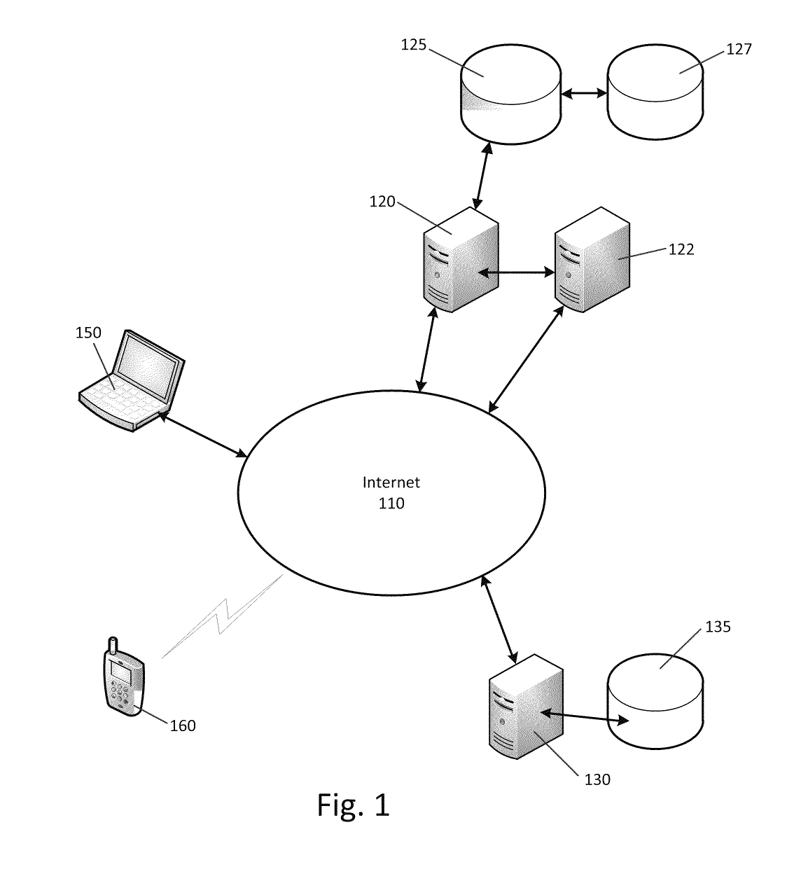

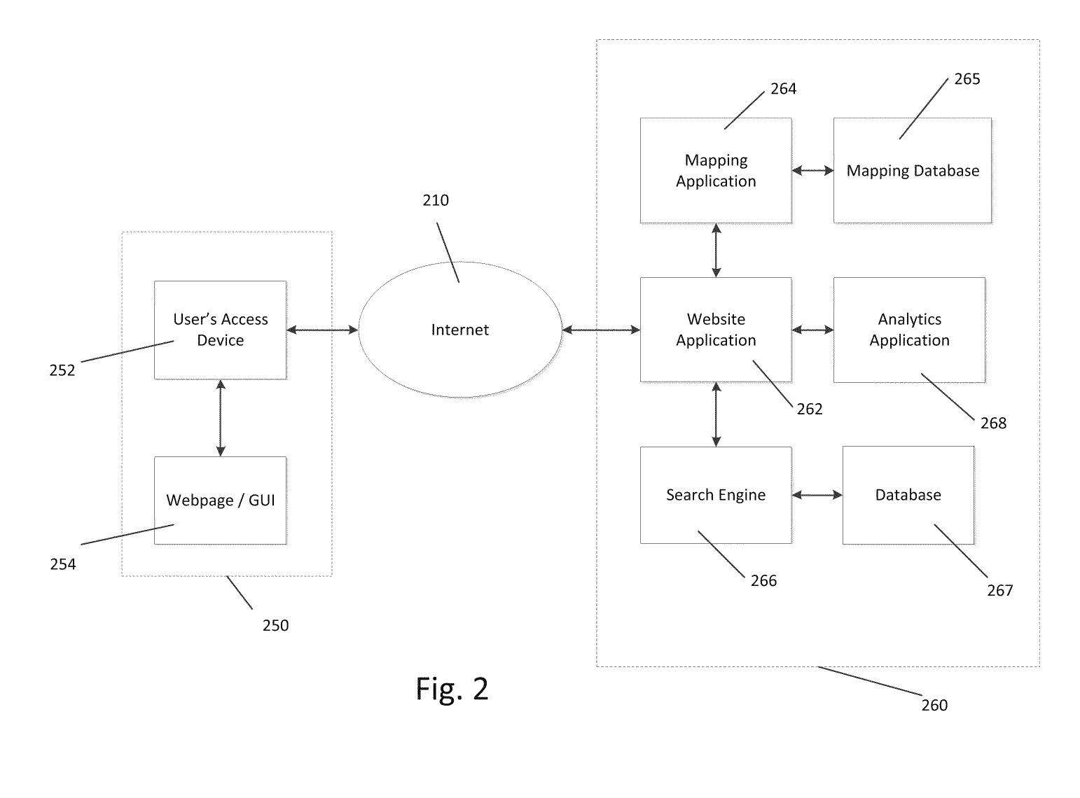

As seen in FIG. 2, the system provides a user system 250 and a restaurant information system 260 which are in communication through the internet 210. The user system 250 includes a communication device 252 which is capable of rendering a webpage or graphical user interface (GUI) on a display 254. The system enables restaurant patrons using their communication device 252 to connect to the Internet or World Wide Web 210 to upload or provide their ratings and reviews of restaurants, chefs, and dishes or meals. The restaurant information system 260 may also interact with various internal or external applications and databases. For example, the system 260 includes one or more applications including a website application 262, a mapping application 264, a search engine or filter 266 and an analytics application 268. The mapping application 264 is connected to and/or in communication with a mapping database 265 and can be used to process the location and directions to the restaurants. Such mapping databases 265 and the mapping application 264 may be on the server 130 (see FIG. 1) or accessed via an API or other data call. Such mapping databases might include popular applications such as MapQuest, Google Maps, and Bing Maps.

Prospective patrons may use their computer or other communication device 252 to connect to the Internet or World Wide Web 210 to interact with the system 260 to search for specific restaurants by various criteria such as location, type of food, price, reviews, or the like. The system 260 is compatible with and accessible by smart phones and other communication devices as well as able to be utilized on the computer.

The system of the present invention provides a restaurant search function which is used by a prospective patron using a computer, smart phone or other communication device 252 to connect to the system 260 through Internet or World Wide Web 210. The system 260 provides access to the various software functions and data of the site, including the restaurant search guide, through the website application 262. The user enters various criteria and performs a search through the search engine or filter 266. The search engine 266 searches the profiles and information available on the one or more databases 266 within the system 260. Once search results are obtained, the prospective patron can then obtain further information from the search results, such as viewing menus, offers, ratings, or reviews. The requested information is pulled from the various databases and transmitted through the internet 210 to the user's computer 252 and displayed to the user on a display 254. The prospective patron is also able to decide on or select a specific restaurant and obtain contact information, maps, or directions to the restaurant. Further, once a prospective patron has dined at the restaurant, she would be allowed to utilize the restaurant search guide system 260 to provide a rating or post a written a review of the restaurant, the chef, or a particular dish form the menu for future patrons to use in selecting their dining experience.

An example of a search would be to enter a prospective patron's current location, or another desired location, such as “Washington, DC” and then “Italian food” as search criteria. This would return a number of Italian restaurants in Washington DC. The prospective patron would then be able to look at various items provided by each restaurant owner and other patrons, such as menus, prices, reviews, photographs, etc, and decide which restaurant meets her specific criteria. The user could provide additional criteria to further filter the results. Finally, the prospective patron could click on a link to mapping or directional websites, input her starting address, and obtain directions to the chosen restaurant. Alternatively, is the user's smart phone includes GPS location services the system can identify her location and provide directions from the smart phone application. After dining at the chosen restaurant, the patron would be free to provide a rating on the restaurant, chef, and specific dish. The patron would also be able to write her own review, which would be entered into the system for review by users of the system and potential future patrons of the restaurant.

The advantage of this invention is that prospective patrons would be able to find restaurants meeting certain criteria, while the restaurants might obtain more patrons who might not otherwise find out about such restaurant absent the use of the restaurant search guide. The restaurant owners could pay a small fee to belong to the restaurant search guide while prospective patrons could also pay a small fee to utilize the restaurant search guide. Another advantage of the invention is that it would create quicker awareness of new restaurants and awareness of menu changes or new dishes and chefs to a known restaurant.

Ideally, the system of the present invention also works as a social network or community platform for restaurants, chefs, and patrons. The system allows a business owner to create a page about the restaurant or a chef to create a page about themselves on the system. The business owner or chef could upload information from a computer, smart phone, or other Wi-Fi or Internet browsing technologies. Further, the business owner or chef could post such information as menus, daily specials, head chefs, and the like, and change such information at anytime from anywhere, utilizing a computer, smart phone, or other Wi-Fi or Internet browsing technology. Each page could be changed and updated daily, if desired. Additionally, prospective patrons are able to link to maps and/or directions, including 360 degree views of the desired restaurant location, and are able to search in such a way as to find restaurants that are “friends”; i.e., are linked to other restaurants. Examples of such links are if an owner had two different restaurants, or a head chef cooked in two different locations, or to link together restaurants with the same type of cuisine, same location, similar prices, or the like.

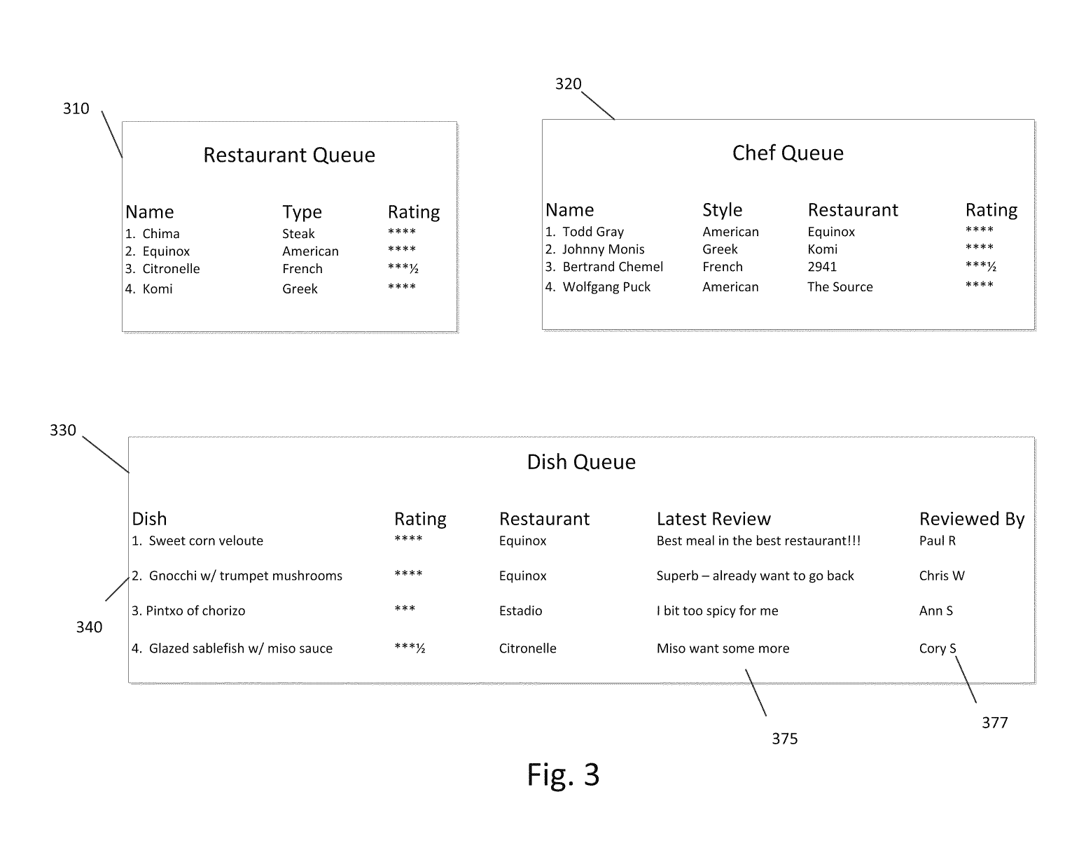

An additional aspect of the present invention, as seen in FIG. 3, is the ability for users to identify or establish queues for restaurants, chefs, or dishes they want to try. Utilizing the restaurant search guide and available information including patron reviews and ratings a user can add restaurants to a restaurant queue 310, chefs to a chef queue 320 or dishes to a dish queue330. The user would be able to move specific entries up or down in the queue order 340. The queue's would also show additional information which might include ratings, type of restaurant, latest review 375, reviewer 377, cost, availability, and top menu selections or dishes. The user would also be able to click on the reviews 375 to read more reviews or click on the reviewer's user name 377 to read that reviewers profile and other reviews. Through this process user's can find other user's they feel have similar tastes and can see the other reviewer's favorite restaurants, chefs, and dishes. Users would be exposed to more restaurants, chefs, and dishes with the ability to add them to the queues 310, 320, 330 and sort rank them through the order 340. Additionally, the queues could be combined allowing the user to create one master queue.

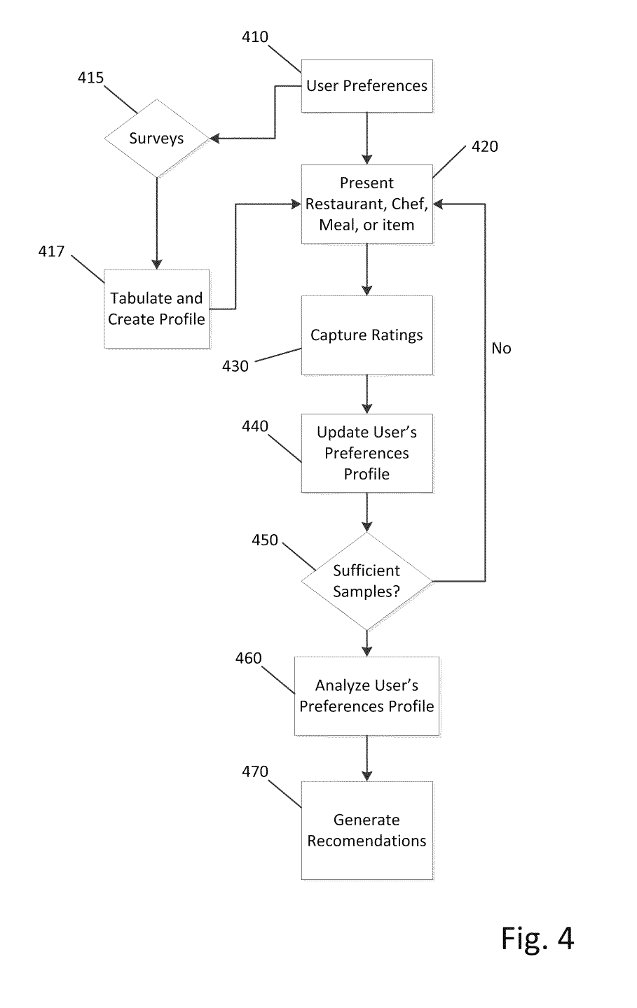

Additionally, upon user registration as might be needed to obtain the maximum value form the system, users can create a profile. Through interaction of the site, answers to profile questions regarding likes and dislikes, search history, ratings and reviews, and a user's queues 310, 320, 330 a base profile is created. As seen in FIG. 4, a process for generating recommendations of restaurants, chefs, or dishes is provided. Initially, a User's profile or preferences are identified from information provided by the user such as information which might come from various questions or surveys 415 to identify a user's likes, dislikes, and preferences. The first time the user goes through the process the system tabulates and creates the user's preference profile in step 417. As the user is provided with additional surveys 415 those responses or preferences are included and the user's preference profile is tabulated or updated 417. Additionally, the user's interaction on the site is also used to update the user's preference profile.

As seen in step 420, users are then presented with various restaurants, chefs or meals/dishes which they can rate. The system can be enabled to rate restaurants, chefs, all items on the menu, drinks, specials, and even the staff. The system captures a user's ratings in step 430. As a user provides ratings the user's preference profile is updated and the system learns the type of restaurants, chefs, and dishes or meals a user prefers based upon ratings. The recommendation process might require a minimum level of ratings to provide effective suggestions thus in step 450 the system might determine if that user has a sufficient number of rating samples for analysis. If not, the user is prompted to rate more restaurants, chefs, or meals or dishes. If the user's profile has some minimally sufficient ratings and information the system can then analyze the user's preference profile 460 to generate recommendations 470.

The analysis includes a comparison of the user's profile preferences against profiles of the restaurants, chefs, and meals or dishes. The comparison also finds user's who have similar preference profiles and similar ratings on various restaurants, chefs, or meals. Through comparative analysis, the system is able to determine restaurants, chefs, and meals which match your profile preferences or restaurants, chefs, or meals that other users with similar profile preferences have provided favorable ratings. Through this comparative analysis the system is able to calculate an estimated rating for restaurants, chefs, and meals or dishes that a user has not yet rated. The system can then generate recommendations 470 and present those to the user. The system can still filter the results based on various criteria the user provides. Such criteria might include the style or type of restaurant (i.e. Italian or French), price, ratings (i.e. above 3 stars), specials, and other factors.

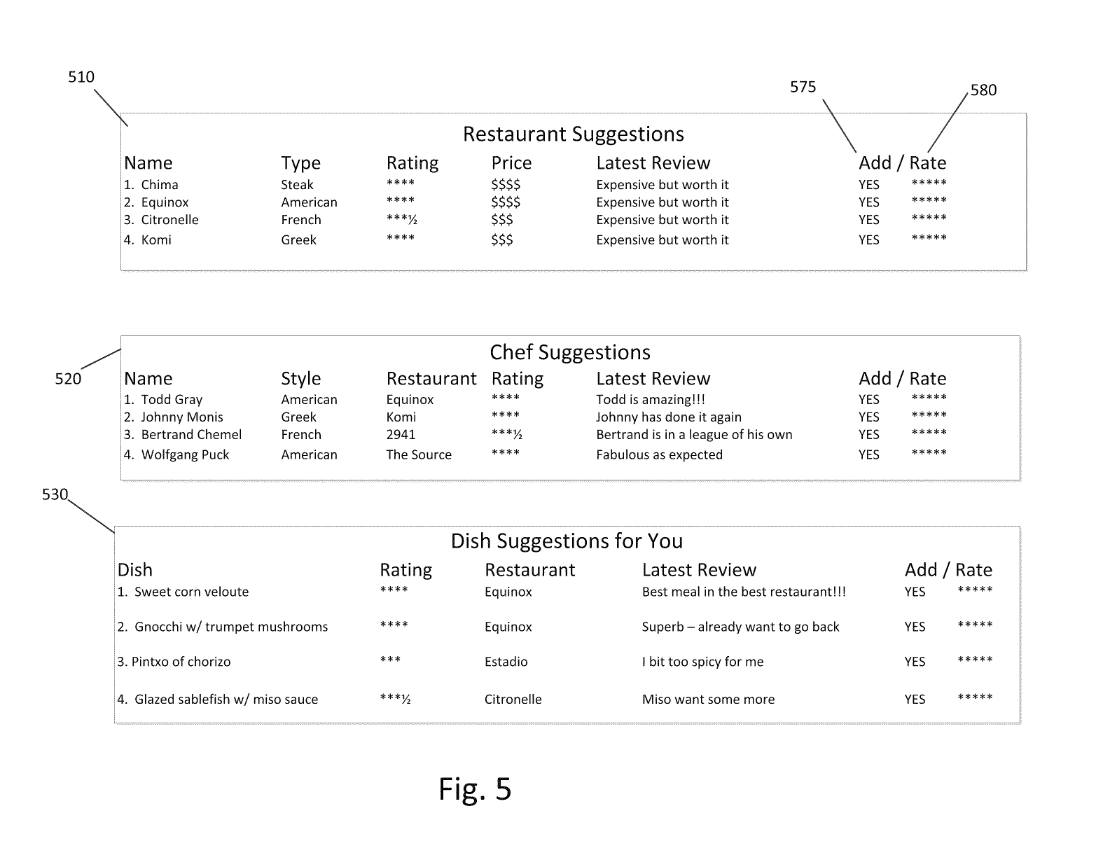

FIG. 5 depicts various information panels which could be presented to the user. The Restaurant Suggestions 510, Chef Suggestions 520, and Dish or Meal Suggestions 530 would provide the user the ability to learn more information about food options. Users can add the restaurants, chefs, or dishes to their queues through the add function 575 or rate them using the rate function 580.

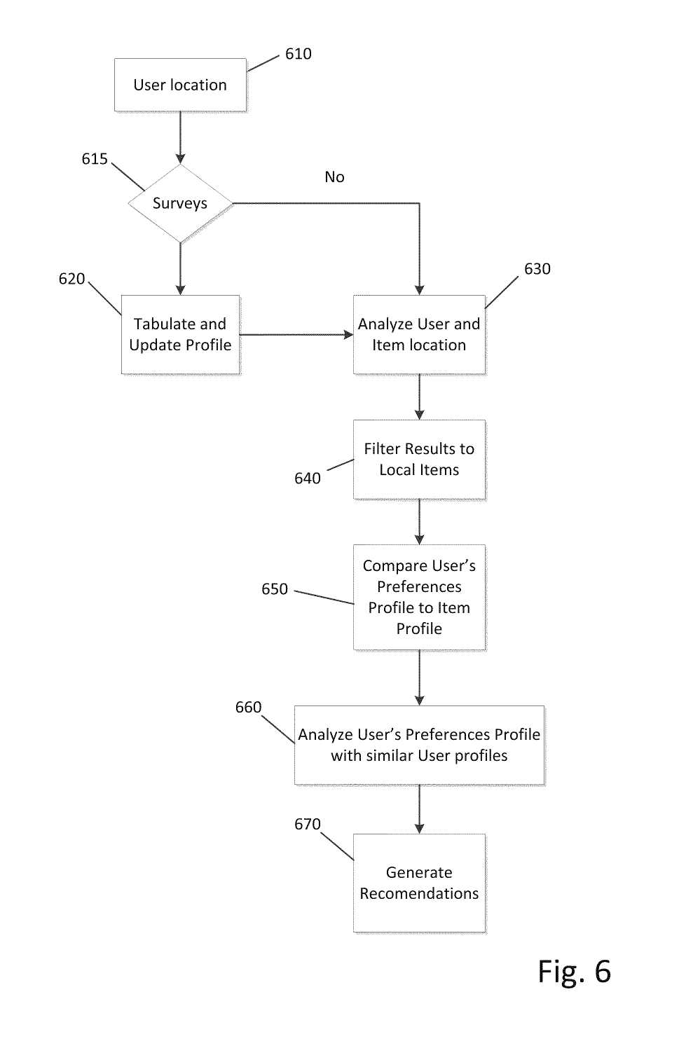

As seen in FIG. 6, the system of the present invention can also filter results and adjust profile preferences in real time. A user can interact with the system and identify their location 610. The location might be entered by the user or identified through the user's smart phone with location service enabled. The user's might be surveyed 615 or can identify various filters such as the type of food they want, their budget, or seating availability. The system would tabulate and update the user's preference profile 620. The updated profile would then be used to analyze 630 the user location and the restaurant, chef, or meal locations. The system would then filter 640 results to local establishments and then compare the user's preferences profile 650 to the restaurant, chef, and meal profiles. The system would then analyze 660 the user's preferences profile with the ratings from other user's with similar preference profiles. Upon completion of all comparisons and analysis the system generates recommendations 670 and presents then to the user. The user can then read reviews, profile and menu information, and make a determination. The system would also allow for users to contact the restaurants to make reservations or to ask questions about the menu and ingredients.

The system also provides an intelligence engine which can predict or estimate ratings for dishes you might prefer on a given menu based on ingredients. Knowing the ingredients of menu items from the various restaurants and chefs the system can create historical profiles of ingredients you prefer or alternatively ingredients you do not care for. Thus the system can suggest meals based on ingredients as opposed to only ratings. Thus a user's palate can be considered as an additional factor. Such factors might include a person's affinity for main ingredients like a type of fish or pasta or their affinity for specific tastes or spices like garlic, curry, or jalapenos.

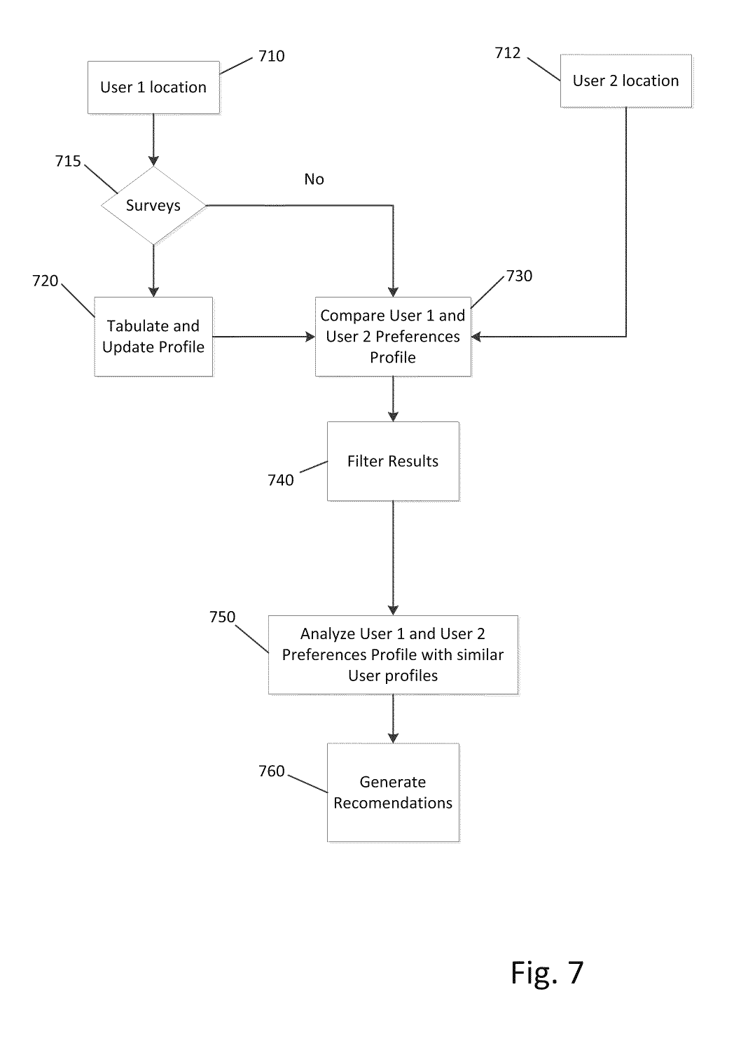

Another feature of the present invention as described in conjunction with FIG. 7 is the ability to factor in the locations and user preferences of more than one user. As seen in FIG. 7, the system can take the location of a first user 710 and a second user 712 when generating the list of recommendations. One or both of the users might be presented with surveys 715 or filter parameters. These filters might include type of food they are interested in, the radius in miles they are willing to travel, cost and the like. The system would then tabulate and update the profiles 720 of one or both of the users. The system would then compare the User 1 and User 2 preference profiles in step 730. The system would then filter the results 740 to local restaurants, chefs, or meals. The system would then analyze the User 1 and User 2 preference profiles with the profiles of the filtered results and the ratings of users with similar preference profiles. The system would then generate a list of recommendations 760 and present those to the users. Since the system is able to analyze preferences down to the menu item the analysis can identify specific meals that each person might enjoy. Thus, the system can assist in determine or selecting a restaurant that would be the most enjoyable factoring in all members of a party going to eat.

The system can also factor in a tiered or hierarchy weighting to the ratings and recommendations. The hierarchy weighting can be applied to provide more weight when determining rating estimations when factoring the ratings of professional food critics, other chefs, users with large followings, users with more reviews, and users who frequent and rate restaurants in the seeking users target restaurant profile. Thus, users that frequent fine dining establishments are more apt to want the ratings of other users that frequent fine dining establishments to account for a much greater influence on the recommendations then users who infrequently visit fine dining establishments. This hierarchy user weighting provides the ability to factor in user's who are more likely to distinguish the subtle differences in fine dining and how those subtle differences impact ratings. Thus, the system can take into account those more accustom to the art and experience of being able to rate and judge a specific dish or meal. In addition, the hierarchy weighting can also be applied to renowned chefs such that the valuable reputations they have built provide value to new restaurants and endeavors which more accurately reflect the consumer demand. This hierarchy system weighting could also be controlled by the user such that user could determine the weighting and settings. The hierarchy system would be applicable to professional critics, travelers, chefs, wine and food clubs and critics, and others with expertise in culture and fine dining. The system also enables the ratings and reviews of publications to be entered and factored into the weighting.

In addition to the benefits available to the user in identifying restaurants, chefs, and meals to prospective patrons, the system is also able to provide valuable feedback and marketing opportunities to restaurant owners and chefs. Since the system enables review down to specific menu items, owners and chefs are able to identify which menu items receive the highest ratings and which do not. They can adjust their menus by quickly removing items with mediocre ratings and focusing their marketing efforts and specials on items receiving the best reviews. Through the constant and specific feedback owners and chefs can quickly improve their menu and ratings to increase their potential.

Further, the system enables restaurant owners and chefs to analyze the user data and preferences to identify users who are high target patrons and to identify meals and ingredients that appear to be favored by local patrons.

Under the first scenario, owners and chefs can identify users who already have the restaurant, chef, or a meal they provide in their queue. This enables the owners to market to individuals they already know want to try their restaurant. Further, they can use the system to identify user's who have given favorable ratings in the past and find users/patrons with similar preference profiles and market to them. This enables restaurants to build a strong and favorable impression and brand as it is more likely to lead to positive or favorable ratings.

Under the second scenario, the owners and chefs can identify in general which meals and ingredients seem to be preferred and most sought after in a given locality. Thus, they can attempt to cater to this need by introducing new menu items and specials. As previously discussed, the owners can then target market to those users who were identified as high interest patrons related to the ingredients or meal.

Additionally, the system can be used by owners and chefs to interact with patrons who provided a less than favorable rating. Owners can interact with the user's to identify what about their meal or experience was problematic and seek to remedy the rating. The system also enables the user and the owner to overcome or exclude certain meals from the ratings and analysis. For example, if an owner has removed a certain menu item which received poor ratings the system could enable the ratings related to that menu item to be removed from the ratings analysis. This would provide a more real time ratings assessment of the restaurant's current menu. The user/patron could also exclude ratings related to a certain meal or ingredient. Thus if a user is looking for the best specific meal in town they might be skewed by other ratings. Thus, the user could limit ratings to only that meal or ingredients he is seeking. By way of example, a user could limit his filter to a specific meal such as crab cakes. Thus the system could exclude all reviews except for crab cakes thereby providing ratings and recommendations based solely on the ratings of the meal the user wants.

Another important aspect of the present invention is the ability for the owner to identify potential problems with this restaurant. Problem identification might be generally ascertainable by reading review or analyzing the ratings. However, the system of the present invention enables owners to dissect the ratings and determine if ratings are higher or lower on certain nights of the week. Knowing which nights receive different ratings might indicate that certain cooks or chefs are favored or disfavored. Further, since the system enables user to rate staff owners can identify staff which have received positive or negative ratings as a means to continually improve the service and ratings.

The present invention also provides the ability for owners and chefs to tailor content and ads based on user preferences and ratings. Thus a user that prefers steak might visit the profile page of a restaurant and see content, ads and specials highlighting steak while a user whose preferences indicate an affinity for fish might visit the same restaurant profile page and see content, ads and specials highlighting fish. Further, owners could cater content and specials based upon a user's ratings and followers. If a restaurant wants to boost their rating they might provide special offers to all user patrons who tend to provide positive ratings or tend to prefer meals which that restaurant has received positive ratings for in the past. This would provide a restaurant the ability to predict a higher likelihood of positive review. Further owners could cater to users with big followings on the site or in the system since those reviews are likely to be seen by more users of the site leading to potential new patrons. Thus, users with followings might be provided specials not available to everyone or received special service.

The system of the present invention can also obtain a user's preferences through survey questions and determine special interests. These might include a user's most memorable dining experience, a guilty food pleasure, favorite desert, or favorite late night snack which can all be used to identify potential patrons or identify new menu items. Owners or restaurants can tailor content and ads based upon these preferences to market directly to high target patrons.

The system can also account for special food pairings. If a user has a wine preference for example the system can identify which restaurants have a preferred wine and filter the list accordingly. OR the system can filter based on a particular spice on ingredient. Thus users could filter out undesired ingredients or filter down to desired ingredients or food pairings. Users could also seek to find which establishments have the best overall rating based on multiple items on a menu such as the main dish, side dishes, appetizers, wine, and desserts. Thus, the system can be used to identify the best overall experience as opposed to just one item. The system can also identify pairings to the user which have received favorable reviews.

As discussed above, the system can enables users to filter based upon meals and ingredients. However, the system can also be sued to reach out to chefs and owners to inquire on the ability to modify a menu item such as to cater to an allergy or to modify a menu to cater to a large group.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed is:

1. A system for generating recommendations of restaurants for a seeking user in a given location by use of the Internet, said system comprising:
a website application for generating a webpage on the internet;
a search application for searching at least one database;
said at least one database containing information on a plurality of restaurants, a plurality of restaurant ratings, and a plurality of preferences of a plurality of other users;
an analytics application for analyzing the information on the plurality of restaurants, the plurality of restaurant ratings, and the plurality of preferences of the plurality of known users with the preferences of the seeking user to generate an estimation of the seeking user's restaurant ratings;
wherein the analytics application uses the estimations of the seeking user's restaurant ratings to provide the seeking user with restaurant recommendations; and
wherein the website application generates and displays a webpage available over the internet for the seeking user to view the restaurant recommendations.

2. The system of claim 1, wherein the analytics application identifies a subset of the one or more known users which have preferences similar to the seeking user and provides recommendations based on the ratings of said subset of known users.

3. The system of claim 1, wherein the analytics application identifies a subset of the one or more known users which have preferences similar to the seeking user and adjusts the estimations of the seeking user's restaurant ratings in response to the ratings of said subset of known users.

4. The system of claim 1, wherein the analytics application identifies a subset of the one or more known users which have preferences similar to the seeking user and adjusts the estimations of the seeking user's restaurant ratings based on the ratings of said subset of known users.

5. The system of claim 1, wherein the analytics application identifies a subset of the one or more known users which have profiles and ratings which are relevant to the type of restaurants being sought and adjusts the estimations of the seeking user's restaurant ratings based on the ratings of said subset of known users.
